(19) United States
(12) Patent Application Publication
(10) Pub. No.: US 2018/0234371 A1
(43) Pub. Date: Aug. 16, 2018

(54) METHOD, SYSTEM AND COMPUTER PROGRAM PRODUCT FOR PROVIDING INTERACTIVE ELEMENTS IN MESSAGES

(71) Applicant: Gobitech AS, Trondheim (NO)

(72) Inventors: Kristoffer LANDE, Trondheim (NO); Kristian REKSTAD, Trondheim (NO)

(21) Appl. No.: 15/429,899

(22) Filed: Feb. 10, 2017

(51) Int. Cl. H04L 12/58

(52) U.S. Cl. CPC H04L 51/18; H04L 51/10; H04L 51/04

(57) ABSTRACT

A method in a messaging server for providing interactive elements in messages is presented. A message containing a definition of an interactive element may be received by a messaging server. The messaging server will store the message, including the interactive element, in a database and associate interactive element with a variable. When the message is transmitted to recipient devices the value stored in the variable is transmitted together with the message in order to be displayed together with the interactive element. A return message may be received from the recipient device if a user chooses to interact with the interactive element. The value stored in the variable may then be adjusted as a result of the receipt of the return message in order to reflect the user interaction with the interactive element. When the message is transmitted to a second recipient device, it will be the adjusted value stored in the variable that is included such that the adjusted value can be presented together with the message on the second recipient device.

### TECHNICAL FIELD

The present invention relates to methods and systems for electronic messaging and social networks. In particular, the invention relates systems and methods for embedding elements providing interactive functionality in such messages.

### BACKGROUND

The Internet has become a global system of interconnected computer networks that use the Internet protocol suite (TCP/IP) to enable computers and other devices to communicate. Access to the Internet can be provided via broadband cable connections, wireless local networks such as WiFi (IEEE 802.11), wired and cellular telephone networks, etc. Consequently, a wide range of different devices are able to communicate over the Internet, and a wide range of services are being provided, often in the form of communication and networking services built on top of the Internet itself. One class of services that have become very popular in recent years are related to messaging or chatting in the context of a social networking service.

A social networking service is an online platform where a certain relationship is defined between users, often by associating them directly with one another as friends or by associating them collectively as members of a common group. Various terms are used for these associations on the different platforms, including friend, contact, connection, member, etc. These terms as such as such are, of course, not technical, and there are no technical characteristics of a system or platform that can be inferred from the use of any particular of these terms.

A messaging service is a service that provides users with the ability to exchange messages in the form of text, images and/or other forms of media content. Many Internet based messaging systems have been introduced over the last few decades, including email, chat rooms, newsgroups, and instant messaging. In addition, text messages, or short message service (SMS) as well as multimedia messaging service (MMS) have been developed specifically for cellular networks. A message may, in principle, include any type of information or media and any combination of media types. The term message does not imply the inclusion or exclusion of any specific type of media such as text, image or sound. Consequently, other terms incorporating the term “message” are similarly general. For example, a messaging server can be any server capable of receiving, storing and/or forwarding messages containing any one or any combination of media or data types, as well as any combination of servers handling message related functionality in a distributed or replicated manner.

The last few years a number of messaging platforms have been extended with added functionality, including rich content creation and editing, the ability to receive feedback from other users—often referred to as likes. Among the most popular is the ability to apply filters or effects to images and to add text and/or standardized graphic elements to an image in the form of stickers, frames, and callouts, and also to create collages.

Interaction between users, however, is typically limited to sending or posting responses. As already mentioned, some platforms provide the possibility to add likes or other expressions of opinion or feeling as a response to somebody else's message, but both the interaction as such and the presentation of the results of the interaction exist outside the original message. It can be presented in conjunction with the original message, but it cannot modify the original message. This may be inconvenient in certain situations, for example when the message and its presentation is primarily image based and most or all of the displays used to present the messages use all of the available display area to present images rather than text.

Presenting information on top of an image or a video is, of course, nothing new in video and television production. It may, however, be more challenging to provide originator of a message with the opportunity to add interactivity, and enable collection and aggregation of the results of user interaction among recipients of the message in order to feed those results back into updated versions of the original message, without any involvement of production equipment and studio professionals. Developing and providing such functionality in a messaging platform may therefore be desirable in order to enable richer communication and interaction between users.

### SUMMARY OF THE DISCLOSURE

In order to meet some of the needs described above, a method in a messaging server for providing interactive elements in messages has been developed. The method may include receiving a message from a sender device including at least one definition of an interactive element to be rendered in conjunction with the message on a recipient device. At the messaging server the message, including a representation of the interactive element, may be stored in a database. In the database, an association between the representation of the interactive element and a variable may be created. The message may then be transmitted to a first recipient device together with a representation of a value stored in the variable. When the message is displayed on the first recipient device, this value can be presented together with the message and the interactive element. If a user of the first recipient device chooses to interact with the interactive element, a return message identifying the message and the interactive element may be sent back to the messaging server. When the messaging server receives such a return message from the recipient representing the user interaction with the at least one interactive element, the value stored in the variable may be adjusted in accordance with the content of the return message. When the same message is transmitted subsequent to this update, it may be transmitted to a second recipient device together with the adjusted value stored in the variable such that the adjusted value can be presented together with the message on the second recipient device. A “return message” does not have to include any user-generated data, but can simply be a passing of information between respective software modules or processes running on the various devices and servers that participate in the messaging system.

In some embodiments, the message includes, together with the definition of the interactive element, a unique identification of the variable on the message server.

The method may further, in some embodiments, include receiving from the sender device, and prior to receiving the message from the sender device, at least a part of a URL identifying a resource that is accessible over a computer network. The messaging server may use this at least part of a URL to search in a database associated with the message server, for an entry associating the at least a part of a URL identifying a resource with a URL identifying a preview image representing the resource that is accessible over a computer network, and upon retrieval of such an entry, send the URL identifying a preview image to the sender device. The message subsequently received from the sender device may now include an interactive element associated with the URL identifying the preview image. This enables a recipient device to display the preview image as an icon or link background for the interactive element.

If the search results in a determination that no such entry can be retrieved from the database, some embodiments of the invention may proceed by sending a request for an URL identifying a preview image to a server hosting the resource identified by the received URL, receiving a response from the server hosting the resource identified by the received URL including a URL identifying a preview image, creating an entry associating the URL identifying a resource that is accessible over a computer network with the URL identifying a preview image, and sending the URL identifying a preview image to the sender device.

Some embodiments of the invention may further include receipt of a message from a sender device including an additional interactive element associated with a group of registered users. The method enables new users to join that group by interacting with the interactive element associated with a group of registered users causing a return message to be sent from a recipient device and back to the messaging server. The messaging server will then receive a return message from the recipient representing a user interaction with the additional interactive element associated with a group of registered user and including an identification of a user, and add the identified user to the group of registered users. A group may also be referred to as a story and a member of a group may be referred to as a follower of that story. These terms are intended to be synonymous in the present disclosure.

In some embodiments, the interactive element is configured to be displayed as superimposed on graphical multimedia content when the message is rendered. Other alternatives are possible, such as embedded in a text part of the message or shown adjacent to the message. The term “rendered” is intended to include display of images, playback of video and playback of audio content included in the message.

The interactive element may include one or more selected from the group consisting of: a text string, an emoji, an icon, an image, and a default background pattern.

In some embodiments the method will, prior to transmitting the message to the first recipient device, transmit a notification including an identification of the message to the first recipient device. This allows users to download the message only upon request. The messaging server will receive such requests for the message from the first recipient device and transmit the message itself as a response to that request.

According to another aspect of the invention, a messaging server system for providing interactive elements in messages is provided. The messaging server system may include one or more processors, a database, and one or more non-transitory computer readable storage media comprising instructions that, when executed by the one or more processors, cause the messaging server system to perform a method according to the embodiments described above. Those with skill in the art will realize that the server system may include any number of standard hardware and software components such as internal data buses, communication interfaces, displays, keyboards and other user input and output devices, operating systems, database management systems (DBMS), web server software, and so on.

In yet another aspect, a computer implemented method is provided comprising receiving a message request including an interactive element, storing the message in a messaging server, forwarding the message to at least one recipient device, receiving a message indicative of user interaction with the interactive element, and incrementing a counter.

According to another aspect, a computer implemented method includes enabling, on a sender device, a user to create a message including one or more interactive elements. A message including at least one interactive element may then be received from a sender device on a messaging server. The method further includes using the messaging server to store the message in a database and create a counter associated with the at least one interactive element. The message, including at least one interactive element, may then be transmitted by the messaging server to at least one recipient device. The method then includes enabling, on the at least one recipient device, the user to view the message and interact with the interactive element, transmitting, using the recipient device, a message indicative of user interaction with the interactive element, and upon receiving the message indicative of user interaction with the interactive element on the messaging server, using the messaging server to increment the counter.

According to yet another aspect of the invention, a computer program product is provided, comprising a non-transitory computer readable storage medium comprising instructions that, when executed on a processor in a messaging server, enables the messaging server to perform the steps of the methods described above.

### BRIEF DESCRIPTION OF THE DRAWINGS

FIG. 1 shows an example of a system according to the invention;

FIG. 2 is an illustration of exemplary user interfaces for a message sender device and a message recipient device;

FIGS. 3a-3c are an example of a message format;

FIG. 4 shows an example of message content;

FIG. 5-7 show sequence diagrams with examples of how messages may flow between components of the system;

FIG. 8 is an example of a database structure for a database in a messaging server;

FIG. 9 is an example of entries in a database in a messaging server; and

FIG. 10 is a flow chart of an example of a method according to the invention.

### DETAILED DESCRIPTION

In the following description, various examples and embodiments of the invention are set forth in order to provide the skilled person with a more thorough understanding of the invention. The specific details described in the context of the various embodiments and with reference to the attached drawings are not intended to be construed as limitations. Rather, the scope of the invention is defined in the appended claims.

In the exemplary embodiments, various features and details are shown in combination. The fact that several features are described with respect to a particular example should not be construed as implying that those features by necessity have to be included together in all embodiments of the invention. Conversely, features that are described with reference to different embodiments should not be construed as mutually exclusive. As those with skill in the art will readily understand, embodiments that incorporate any subset of features described herein and that are not expressly interdependent have been contemplated by the inventor and are part of the intended disclosure. However, explicit description of all such embodiments would not contribute to the understanding of the principles of the invention, and consequently some permutations of features have been omitted for the sake of simplicity or brevity.

The present invention relates to systems that are implemented at least in part on various types of computing devices configured to be able to communicate with one another over a communication network, which may typically involve the Internet. A number of different communication protocols (such as TCP/IP, HTTP), information formatting and presentation standards (for example HTML, XML, CSS), programming and/or scripting languages (for example C, C++, Java, Javascript), and database management systems and query languages (such as SQL) may be used in the implementation of the invention. These are well known to those with skill in the art, and they are not part of the invention as such, so no attempt will be made to describe them in any detail. Similarly, no detailed description will be given of standard computer hardware such as processors, transitory and non-transitory computer readable storage medium, communication network interfaces, displays, or other components that can be part of the various computing devices of the system.

In the present disclosure, the word element will be used to refer collectively to any text, emoji, image or other object that can be inserted into a message and displayed as part of the message, particularly as superimposed on a background image or video. Interactive element will be used for elements that include or are associated with some ability to receive user input and initiate some action based on this user input. Those with skill in the art will understand that it is only possible to interact with an interactive element when it is displayed on a recipient device along with the message of which it is part. In the present disclosure and the appended claims the interactive element as it is included in the message that is sent from a sender device may therefore be referred to as a definition of an interactive element. A description or representation of the interactive element is a stored or transmitted version of the definition of the interactive element. This description or representation may have the same format as the definition, or it may be converted to a different format. It should be noted that “included in the message” does not exclude the possibility of sending the message in several parts, for example one part with media content (text, images, video etc.) and another part with interactive element definitions.

In the exemplary embodiments described below, such elements are primarily described as stickers. The description of specific types of elements in the context of the examples is not intended to be interpreted as a limitation on the scope of the invention. Consequently, whenever an example mentions a specific type of element, for example a sticker, those with skill in the art will realize that the example can be generalized to apply to any type of element that can be inserted into a message.

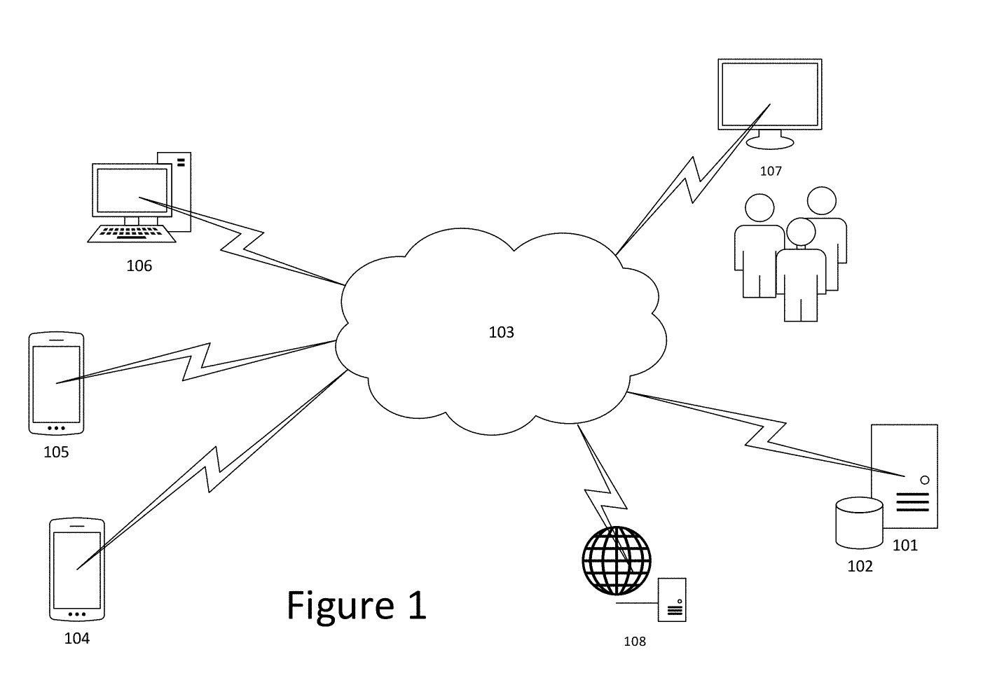

FIG. 1 illustrates an overview of a system of interconnected computers and other electronic devices that are capable of implementing aspects of the invention. The system includes a first server computer 101 with an associated database 102. The first server is a messaging server and the associated database 102 is capable of storing information relating to users, messages, as well as other information as will be explained in further detail below. In practical, large-scale installations, the first server computer 101 may actually be a collection of multiple servers that implement replicated and/or distributed functionality.

The server is connected to a network 103 such as the Internet. Also connected to the network 103 are client devices such as, for example, smart phones 104, 105, personal computers 106, and electronic billboards 107.

The various client devices connected to the system may run client software that allows the device to perform various functions or aspects of the invention, and one device may typically be able to operate at least both as a sender and as a recipient of a message. Unless otherwise stated, for the examples provided herein, it can be assumed that a message originates from a first client device 104 and is received and displayed by various types of other client devices 105, 106, 107.

Finally, a web server 108 is shown. The web server may deliver content such as web pages, images, multimedia content etc. upon request.

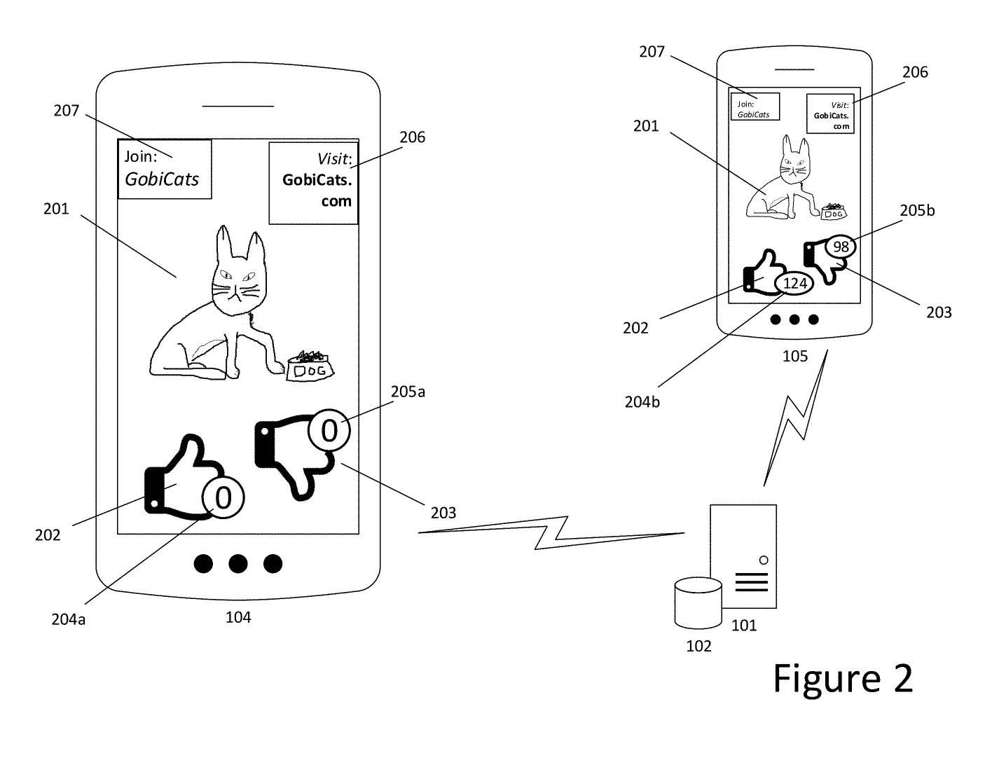

Reference is now made to FIG. 2 which shows an example of a first device 104 preparing to send a message including an image 201 and four embedded interactive elements 202, 203, 206, 207. Two of the interactive elements include, in this example, an emoji 202, 203 and a number 204, 205. The numbers 204, 205 represent dynamic information that can be updated as a result of interaction with the embedded objects 202, 203 by recipients of the message. The two additional interactive elements represent a link 206 to external content and a request 207 to join a group (or follow a story). Technically speaking, a group and a story is the same thing with respect to the invention, and the words will be used interchangeably in this disclosure. A group can be thought of as the people following the same story, and a story may be thought of as the content published sequentially to the members of a group.

In the example illustrated in FIG. 2, the message is an image 201 of a cat, which is apparently considering whether to steal the dog's food. The embedded interactive elements 202, 203 are a thumbs-up emoji 202 and a thumbs-down emoji 203 which will allow recipients to vote on whether they think the cat should go ahead and steal the dog food. The numbers 204a, 205a are currently at zero because the message has not yet been sent and no interaction has taken place.

When the message is sent, it is first routed to a message server 101. In the message server 101 the message is registered in a database 102 and a notification is sent to the intended recipients. The entry of the message in the database includes registration of interactive elements embedded in the message. Whenever a recipient receives and displays the message on a recipient device 105, the image 201 along with the embedded objects 202, 203 will be displayed. If a recipient chooses to interact with one of the embedded interactive elements by clicking or touching them, a message will be returned to the message server 101 and information in the database 102 relating to the interactive element that was selected by the recipient will be updated. If the message is sent from the message server 101 subsequent to this update, the embedded interactive elements 202, 203 will include the updated information on user interaction.

In the example shown in FIG. 2, user interaction has resulted in updated numbers 204b, 205b showing that 124 users have given the cat thumbs up to go ahead and steal the dog's food, while 98 users have shown that they feel sorry for the dog and that they want the cat to stay away from the dog food.

The two additional interactive elements, or stickers, as well as message transfer, message formats, and database storage will be described in further detail below.

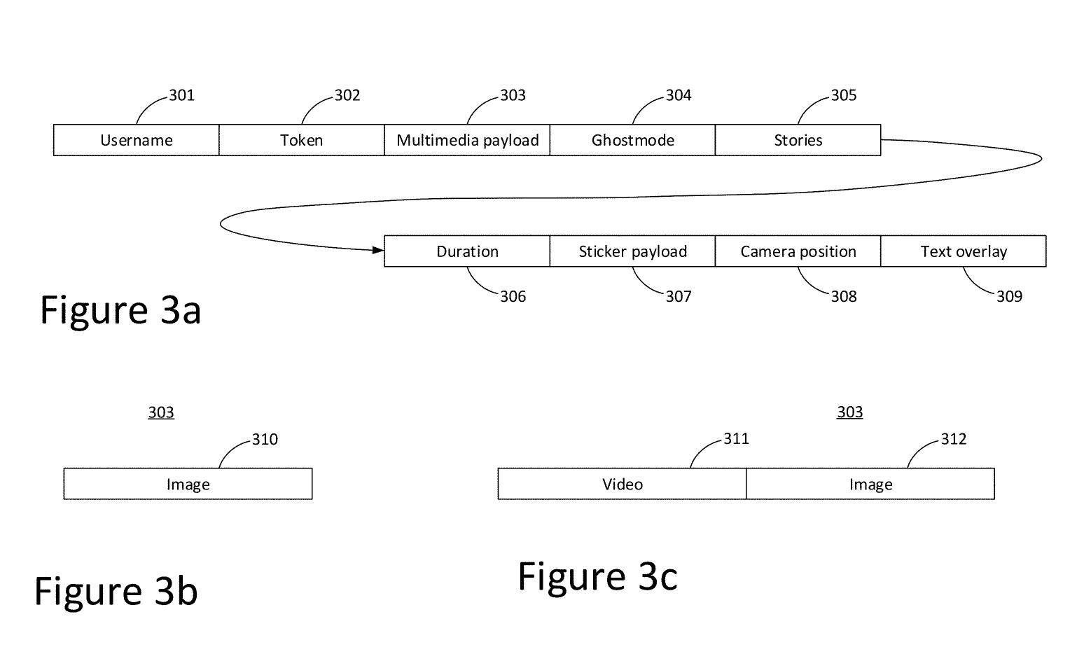

Turning to FIGS. 3a-3c, an example of a message format consistent with the invention will now be described. In FIG. 3a the various fields or entries constituting the message is shown. The message starts, in this example, with a username 301, which is the name of the user who created and sent the message. The next field is a token 302 which is used to authenticate the user with the server. The token may have been obtained when the user first connected with and logged into the messaging server 101. Token based authentication is well known in the art and will not be described in further detail here. The username and the token may both be text.

The next part of the message is the multimedia payload 303, which will be described in further detail below.

The next field in the message is called ghostmode 304 and is simply a variable indicating whether the user wants to show their name or username with the message, or that the message should be anonymous. The value may, for example, be limited to the digits 0 and 1.

The field stories 305 may be a comma separated list of stories (or groups) where the message should be posted. The names of the stories may be encoded in base64.

If the multimedia payload 303 is a video, then duration 306 is the length of the video. If the multimedia payload 303 is an image, the duration stored in this field is the length of time the image should be displayed by a recipient device 105 when the message is opened. In various embodiments of the invention, the multimedia payload 303 may include other types of content, such as audio. A recipient device may render the different types of multimedia content upon receipt. In some embodiments of the invention a message may include only non-graphical content such as, for example, a voice message. If a message does not include other graphical content than that associated with a sticker, the sticker may be displayed in conjunction with the playback of the audio content of the message. In the examples described herein, however, it is assumed that the messages include graphical multimedia payload that is displayed by the recipient device. This assumption is made in order to simplify the explanation of the invention, not in order to limit its scope.

The sticker payload 307 contains the definition of the interactive elements. The message format may be JavaScript Object Notation (JSON), although other alternatives such as XML are possible. The sticker payload may include such data as a sticker's position in the larger image or video, URLs, data that represent results of interaction, other embedded data (e.g. binary or base64), etc. The sticker payload will be described in further detail below.

The camera position 308 indicates whether the video or image in the multimedia payload 303 was obtained using a front or a main camera on a smartphone type device, since videos and images obtained with a front camera may have to be flipped.

The text overlay 309 may be text that should be displayed for example as a banner or marquee on top of the image or video message. The text may, for example, be encoded as plain text or base64.

FIG. 3b shows what the multimedia payload 303 may look like if the message is an image, namely an image file 310 embedded as binary data in the message. FIG. 3c shows an example of how the multimedia payload 303 may include video 311, for example in the form of a zip file with any overlay such as drawings, text, and stickers (i.e. non-interactive stickers in the form of graphic elements) rendered as a transparent Portable Network Graphics (PNG) image and an image 312 comprising a single frame from the video combined with the overlay image. The image 312 can be used as a static representation of the video prior to or following playback of the video, and it may also be used to generate a thumbnail representation of the message. The video 311 and the image 312 may both be embedded in the message as binary data.

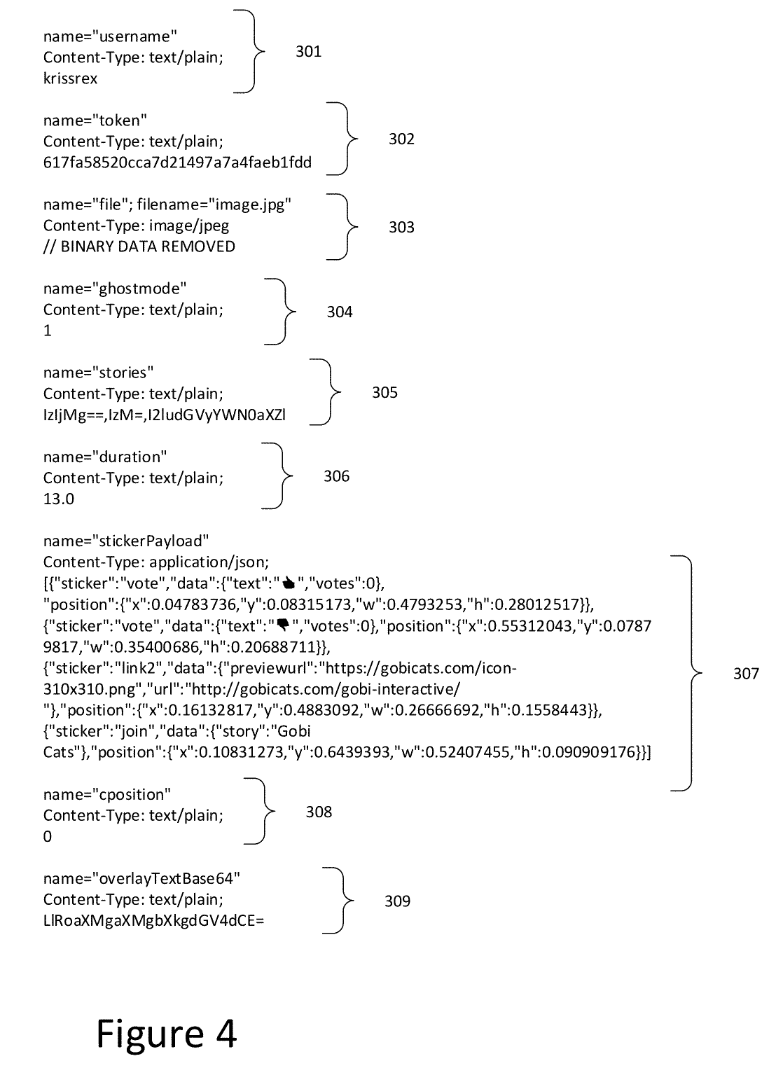

In embodiments of the invention the message format does not require any specific sequence for the various fields or entries. Instead, each entry is given a name and a definition of content type, for example in the form of media type identifier (often referred to as MIME type). This is illustrated in the example presented below with reference to FIG. 4. It is, however, consistent with the principles of the invention to use a message format where content is defined by their position in a predefined message structure.

The various fields presented above are not all strictly necessary, and in principle, any one of them can be left out or combined with other fields, depending on whether the data they provide are required in a specific message or a specific embodiment of the system. It will also be realized that different forms of encoding may be used instead of those mentioned in the example.

FIG. 4 shows an example of a message consistent with the exemplary message format described with reference to FIGS. 3a-3c and where the sticker payload 307 is in a JSON format. The reference numbers in FIG. 4 are the same as those shown in FIGS. 3a-3c.

The first part of the message is the username 301, which in this case is “krissrex”. The token 302 is a long character string in text format. This particular message contains an image and the next part of the message, the multimedia payload 303, 310, therefore includes a file name and a lot of binary data which has been removed from this example in order to save space.

The ghostmode 304 part of the message simply includes a “1” indicating that the user wants to be anonymous. Conversely, a “0” would turn ghostmode off and the user's name, username or some other identification of the user may be included with the message.

The list of stories (groups) 305 to which the message will be sent follows. In this example, three comma separated base64 representation of the names “#2#2”, “#3” and “#interactive”. It should be noted that these names were used for demonstration purposes and test groups, and that any arbitrary group name could be used as the name of a group. The #-symbol serves no specific purpose here. They were used to identify them as test groups and bring them to the top of the list of groups/stories during testing of the system.

Next, the duration 306 is defined as 13.0 seconds.

The sticker payload 307 is JSON formatted and, in this example, includes four stickers. Two of the stickers are “vote stickers”, one sticker is a “link sticker” and one sticker is a “follow sticker”.

The stickers all include position data, which in this example includes an x and a y coordinate defining a point in the image or video included as multimedia payload 303. The point can, for example, determine the position for one corner of the sticker image in the overall image. In addition, a width, w, and a height, h, are included. The width and height are defined, in this example, relative to the overall size of the message image. Other alternatives for specifying position and size are known to those with skill in the art.

In addition, the vote stickers include data related to the voting, i.e. they provide interactivity in accordance with the present invention, wherein data generated by user interaction is transmitted back to the message server 101, and where such data is aggregated in order to be included in later transmissions of the same message. The two link stickers in this example include text in the form of emoji. The first link sticker has a thumbs-up emoji, “ [symbol] ”, and the second link sticker has a thumbs-down sticker, “ [symbol] ”. Any other text could, of course, also be entered by the user who created the message. The emoji could also be represented by hex code, in which case thumbs-up would be “%f0%9f%91%8d” and thumbs-down would be “%f0%9f%91%8e” according to URL encoded UTF-8 of Unicode emoji characters.

A link sticker includes a URL pointing to the relevant content, in this case http://gobicats.com/gobi-interactive/, and an additional URL pointing to a preview of that content. When the recipient device 105 receives the message it will fetch the preview image and use it as the link sticker representation on the display.

A follow sticker, which may also be referred to as a join-sticker, is a sticker which, like a vote-sticker, which refers back to the message server 101. However, in this case the message that is sent back to the server does not represent an instruction to increment a counter, but to add the user to a specific group. The group does not have to be a group to which the message with the follow sticker has been posted. In this example the group, or story, is “Gobi Cats”, which is different a different group from the groups “#2#2”, “#3” and “#interactive” to which the message was posted.

The camera position 308 part of the message includes a “0” indicating that the back (main) camera was used and that it is not necessary to flip the image. The final part of the message is the text overlay 309, which in this example is the text “This is my text!” encoded using base64.

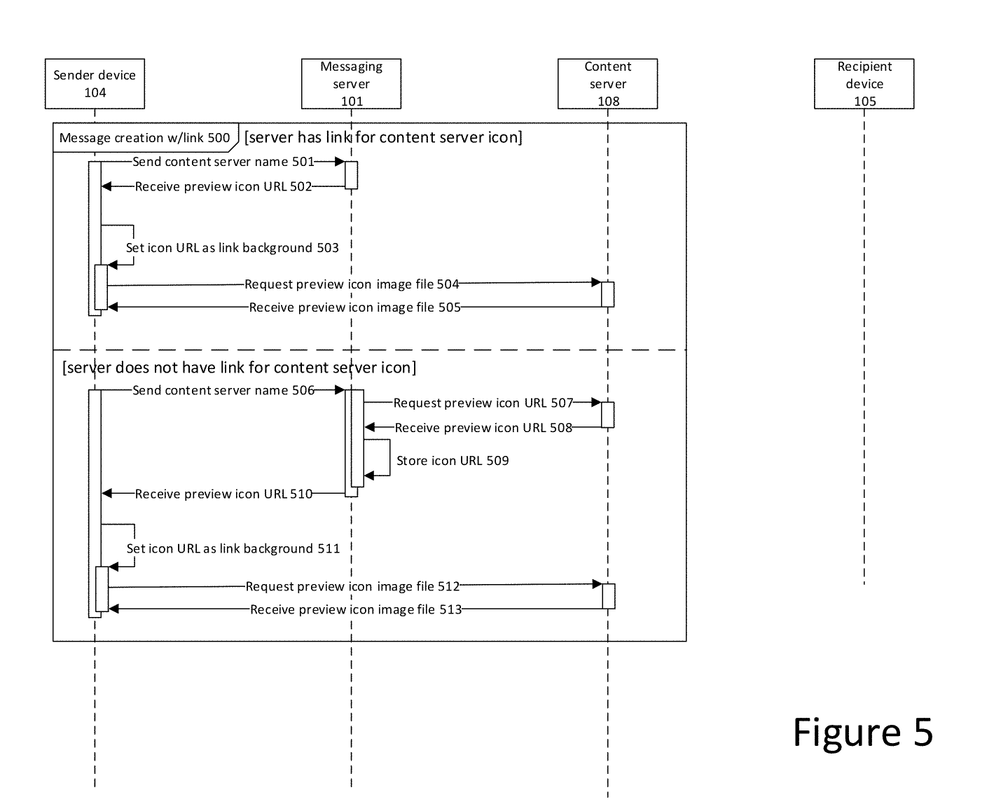

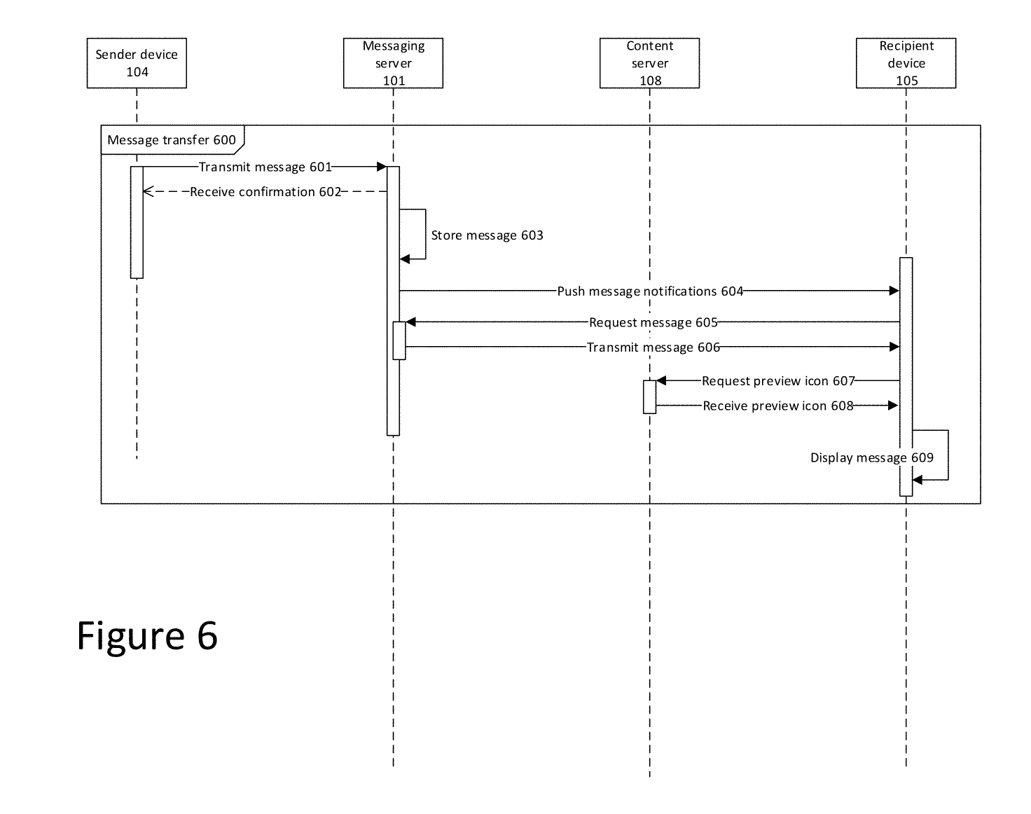

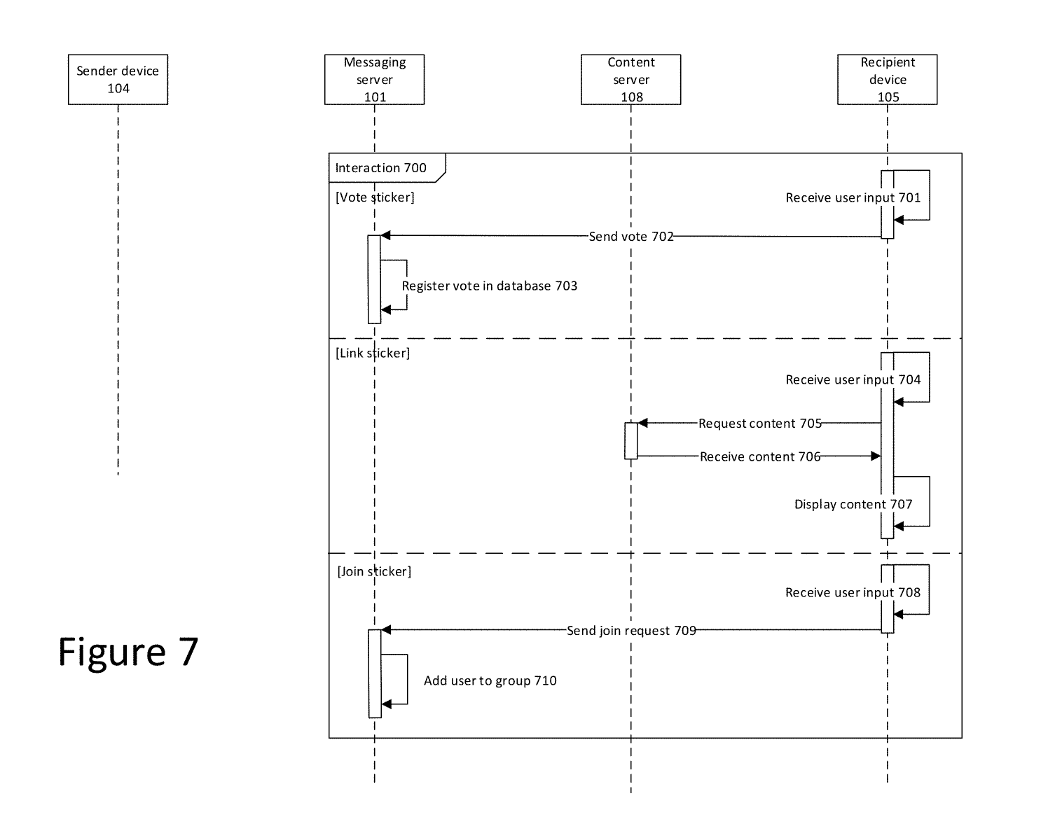

FIG. 5, FIG. 6 and FIG. 7 are sequence diagrams that show examples of how messages may flow between the various components of the system. A sender device 104, a messaging server 101, a content server 108 and a recipient device 105 are represented in the diagrams. The messages may, for example, be sent as HTTP requests. A number of request methods are supported by the HTTP protocol. Embodiments of the invention may typically use POST requests, particularly when information is transmitted from a client device 104, 105 in order to be stored on or by the receiving messaging server 101. For requests that exclusively requests information, the GET method may typically be used instead.

Referring first to FIG. 5, it will be described how messages are exchanged during a user's creation of a message 500. A user operating the sender device 104 may configure a message by adding an image, adding any stickers and configuring their size, text and position, selecting one or more recipient groups or stories, and setting parameters such as ghostmode and duration. The user may also add vote-stickers and join-stickers, which in this embodiment does not initiate any exchange of messages during message creation. In other embodiments, even addition of these types of stickers could include requesting information or images from the server, for example a list of available groups to join, addition of vote stickers that are configured to interact with already existing polls, or access to images that may be used as sticker backgrounds.

After the user has added a link sticker and entered a URL for the content to which the sticker should refer, a shorter URL, truncated to include only the protocol and the domain name, but excluding any path, parameters and fragments, is sent 501 from the sender device 104 to the messaging server 101. In other embodiments, a larger part or the entire URL may be sent to the messaging server in this step. If the messaging server 101 has already been in contact with the content server 108 defined by the URL, a preview icon URL, i.e. a URL referencing an image file stored on the content server 108 as representative of that server or web site, may already be stored on the message server 101. The message server 101 may then respond to the request from the sender device 104 by transmitting a message including the preview icon URL 502 back to the sender device 104. The client installed on the sender device 104 may now set the preview icon URL as link background 503. The client application may then send a request from the sender device 104 to the content server 108 requesting the preview icon image file 504. Upon receiving the preview icon image file 505 the link background can be displayed as part of the message that is being created. An example of this is the element 206 shown in FIG. 2. Some embodiments may allow the user to enter text that will be superimposed on top of the link background image, while other embodiments simply uses the preview icon as the only representation of the link.

If the sender device 104 sends the content server name (the truncated URL) to the messaging server 506 and the messaging server does not have the link to the preview icon already stored in its database, a request for a preview icon URL 507 is sent to the content server 108, and the content server 108 responds by transmitting the preview icon URL 508 back to the message server. The message server 101 will, upon receipt, store the preview icon URL 509 in its database 102 in order to have it available upon later requests. The message server 101 may then transmit the preview icon URL 510 to the sender device 104. The messaging client on the sender device will then, as already described, set the preview icon URL as link background 511, and request 512 and receive 513 the preview icon image file.

In FIG. 6 the further exchange of messages is illustrated in a sequence diagram that represents a continuation of the illustration in FIG. 5. This diagram illustrates message transfer 600 and starts when the created message is transmitted 601 from the sender device 104 to the messaging server 101. The messaging server 101 may now send a confirmation 602 back to the sender device 104. The messaging server may now proceed to store the received message 603 in a process that will be described in further detail below. Following this, the messaging server 101 may start pushing message notifications 604 to members of the groups to which the message is posted, in this example represented by recipient device 105. The received notification may be stored in a list of received notifications on the recipient device 105, and when a user decides to view a message by selecting the corresponding notification from this list a message request 605 is sent to the messaging server 101. The message server 101 responds by transmitting the message 606 to the recipient device 105. If the message includes vote interactivity, as will be explained in further detail below, the message will be transmitted with updated interaction data. When the recipient device 105 receives the message it may display the message 609, including any stickers.

The sequence diagram shown in FIG. 7 illustrates the subsequent sequence of messages exchanged if and when the user of the recipient device 105 choses to interact 700 with the interactive stickers. According to the exemplary embodiment described here, there are three different stickers with which the user can interact. The first possibility is that the message includes a vote sticker. When the client application on the recipient device 105 receives user input 701 representing user interaction with a vote sticker, a message, or vote, is transmitted 702 back to the messaging server 101. The messaging server 101 will examine the received vote in order to determine which story, message and vote sticker the vote can be associated with and update the database accordingly. Subsequent transmissions of the message from the messaging server 101 will now include a value updated to reflect the received vote. The client application on the recipient device 105 may update the value in the received copy of the message to reflect the vote entered by the user.

If the user chooses to interact with a link sticker, user input is received 704 and the client application transmits a request for content 705 identified by the URL to the content server 108. The content server 108, which may be a typical web server, may respond by transmitting content 706 to be received by the recipient device 105. The received content may then be displayed 707 on the recipient device. The messaging client application on the recipient device may have different capabilities in different embodiments with regard to how received content is handled. Consequently, the client application may be able to display the content itself, or it may have to invoke a different application and forward the content to that application. Which application to invoke may be registered as part of the configuration of the messaging application itself or with the operating system of the recipient device 105. Handling of different content types and messaging between applications running on the same device is well known in the art and will not be explained in further detail.

Finally, if the sticker with which the user interacts is a join sticker, the messaging client application receives user input 708 indicating this and a join request message 709 can be generated and transmitted to the messaging server 101. The messaging server 101 will process the received message to add the 710 identified user to the group identified in the join request.

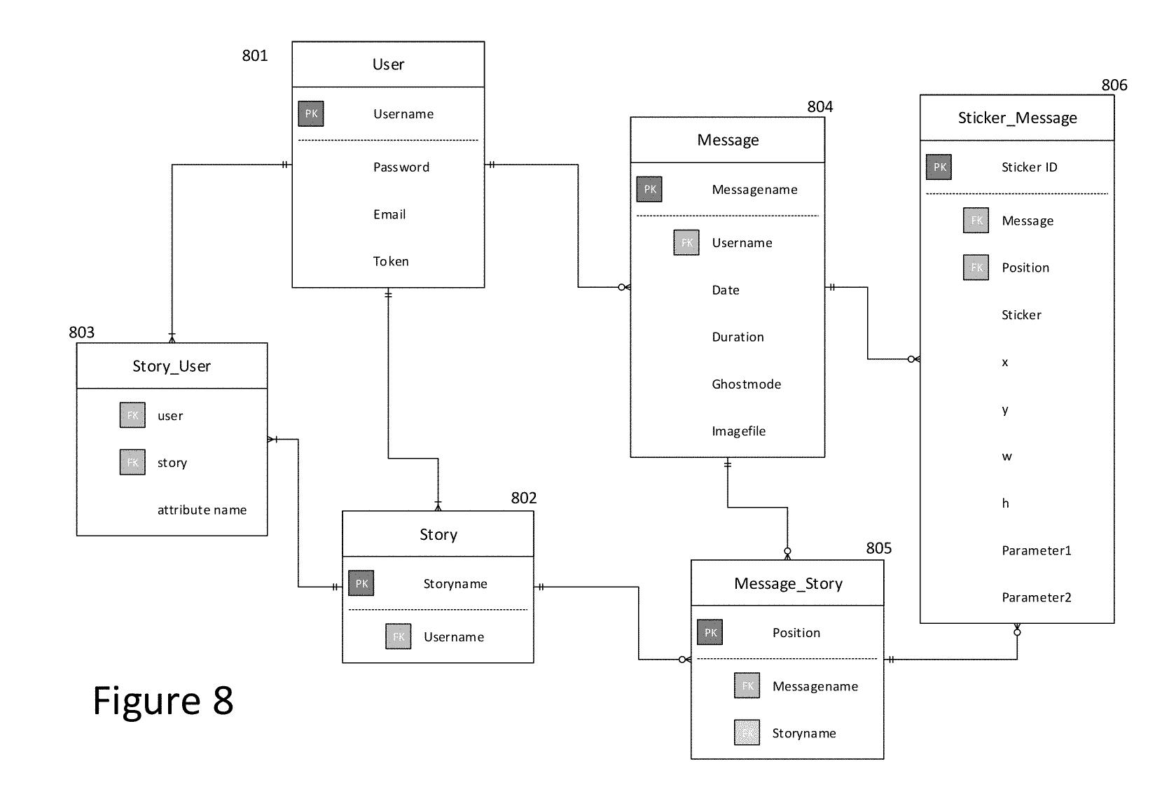

Reference is now made to FIG. 8, which is a simplified relationship diagram for the data stored in the messaging server's database 102. The diagram is simplified in the sense that the illustrated tables in most working embodiments of the invention will include data fields, or attributes, in addition to those illustrated in the drawing, and that the database also will include additional tables. The selection shown here are intended to provide the necessary information to facilitate understanding of the invention as such, not to give a complete specification for the database 102.

A first table 801 holds user information. An entry in this table may include the user's username, password, email address, and a current token. Token authentication has already been mentioned above, and is well known in the art. The token may serve the purpose of simplifying authentication or making repeated logins unnecessary, while also functioning to establish a state for the communication with the users, something that is made necessary by the fact that HTTP is a stateless protocol. The username may be the primary key for entries in this table.

A next table 802 is a table of stories (or groups). A story may include a storyname as its primary key, and a foreign key reference to the username in table 801 for the user who created the story. If a user chooses to follow a story, this can be entered in a third table 803. The Story_User table 803 is a junction table, which establishes a many-to-many relationship between the User table 801 and the Story table 802 by including, in each entry, a foreign key reference to one entry in the User table 801 and one entry in the Story table 802. This makes it possible for many users to follow the same story, and for any user to follow many stories.

A next table is the Message table 804, which is a table representing all messages that have been sent to the message server 101. Each entry in the message table 804 has a Messagename, which is the primary key for the message entry. In addition, the message has a foreign key reference to a user in the user table 801 identifying the user who created and sent the message. In addition, the message may have a date or time stamp representing when it was sent from the sender device 104, or alternatively when it was received by the messaging server 101. Another field represents the duration of the message, which is the duration of a video included in the message or the length of time the image should be displayed by a recipient device 105 when the message is opened. A next field is used to store the ghostmode indicating whether the user should be anonymous. Finally, a field is used to reference the image or video file holding the image that constitutes most of the message payload. The image data is extracted from the message by the messaging server 101 upon receipt and stored as a separate file. A unique filename is assigned to the image file by the messaging server 101. The file may in principle be any type of media file or compressed media file (e.g. ZIP) a given implementation of the invention is configured to handle.

Since the file name uniquely defines the image or video payload and is unique to the image or video, some embodiments may utilize the filename as the name of the message. In these embodiments, there is no separate field for the file name and instead the Messagename field, which is the primary key in this table, holds the file name and thus serves both as a unique identifier of the message and as a reference to the image file.

Since a given message can be posted to more than one story simultaneously, as already described above, it is necessary to create a many-to-many relationship between the Message table 804 and the Story table 802. This is done by the Message_Story table 805. An entry in this table references one message in the Message table 804 and one story in the story table 802. Thus, a message that is posted to three different stories will have one entry in the Message table 805 and three entries in the Message_Story table 805. This ensures that one message can be posted to many stories, and that one story can include many messages.

The Message_Story table 805 may also include a primary key, which in the example in the drawing is referred to as Position. The position serves to define an entry in the Message_Story table 805 uniquely, and also represents a position in the sequence of messages posted to the server. It will be understood that this means that while Messagename in the Message table 804 represents the identity of a message, Position in the Message_Story table 805 represents the instance of a message in a given story.

A Sticker_Message table 806 is used to represent each individual sticker in a message. Each entry in the Sticker_Message table 806 references a message in the Message table 804 and a position in the Image_Story table 805. From this it will be realized that a reference to a position in the Image_Story table 805 is an implicit reference to a message in the Message table 804. The reference in the Sticker_Message table 806 to a message in the Message table 804 is therefore strictly speaking redundant and can be omitted.

The Sticker_Message table 806 also has columns for Sticker ID, which is the primary key of this table, for the sticker type, and for position and size parameters x, y, w and h described above. In addition there are two parameters, Parameter1 and Parameter 2, which hold parameters relating to the sticker. What each parameter holds depends on the type of sticker type. In some embodiments of the invention, the parameters for a vote sticker will hold the text or emoji that will determine what the sticker will look like and the other parameter will represent the number of votes that sticker has received (in that story). For a link sticker the two parameters will hold the URL for the link and the URL for the preview icon. For a join sticker only one of the parameters may be used to represent the story (or group) that can be joined by interacting with the join sticker.

It will be understood from the exemplary embodiment described above that a received message and any included interactive element in the form of a sticker or in any other form, may be represented in the database 102 by information distributed between several tables. Consequently, the message as a whole as well as the various components of the message, are represented, or described, by what is stored in the database 102, but not necessarily in the same format as that in which it is received by the messaging server 101. It is, however, consistent with the principles of the invention to store messages and sticker definitions exactly as they are received.

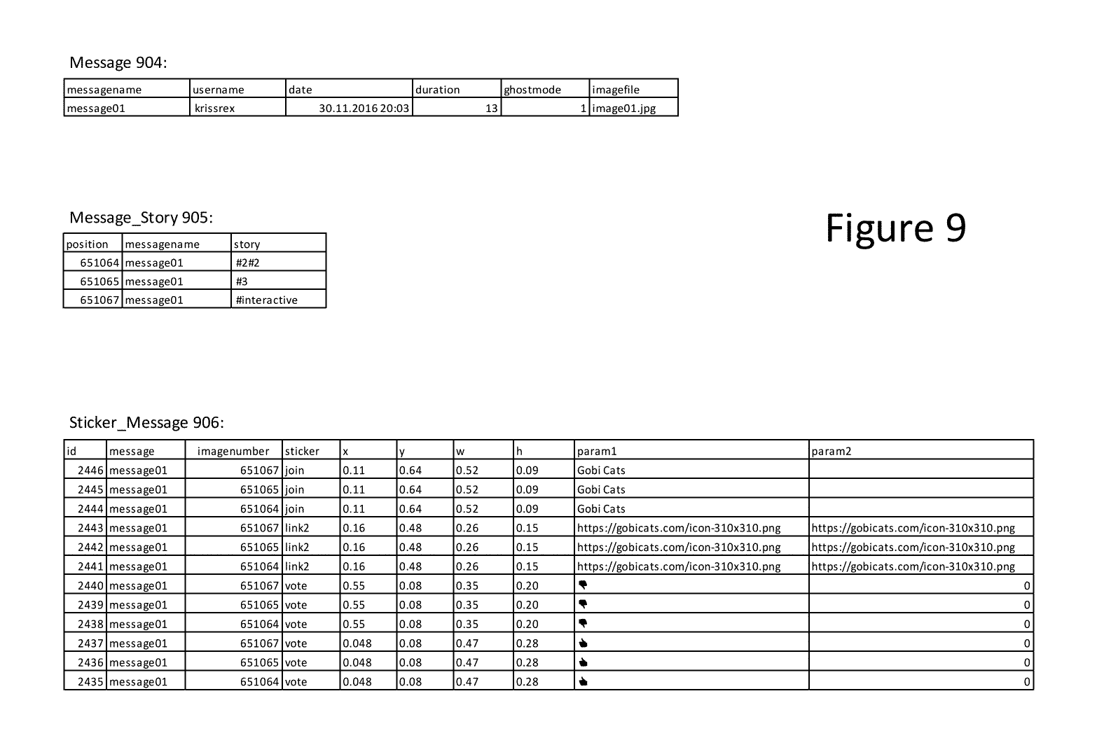

FIG. 9 is an example of how the information received as part of the message in FIG. 4 may be entered in some of the tables shown in FIG. 8. The tables shown in this drawing may be interpreted as excerpts from three of the tables in FIG. 8. A first table 904 represents the entry of message01 in the Message table 804. Next, a table 905 represents the entries in the Message_Story table 805 that represent message 01 in the respective stories to which the message is posted. Since the message is posted to three stories there are three entries in this table relating to this message.

A final table 906 lists the entries in the Sticker_Message table 806 that represent each of the four stickers in the message in each of the three stories to which the message is posted. This table therefore holds twelve entries relating to this message.

It should be noted that since parameter 2 in this embodiment counts votes separately for each story, the resulting votes may also be presented as if the poll in each story are separate polls. However, it is also possible to aggregate these numbers when they are presented. In some embodiments, this may be selectable by the user when the message is created. In other embodiments, the vote parameter may be a parameter which is associated with the message entry in table 804. Those with skill in the art will realize that also other parameters may be stored in the message table 804 instead of in the Sticker_Message table 806. The invention as such is not limited to any one particular distribution of information between tables, and a particular implementation of the invention may be based on a database design where tables and information are structured and distributed differently than illustrated in this particular example. The principles of the invention do not require sophisticated database design, and as such, it is in accordance with the principles of the invention to implement the database 102 as a single table or file. The database 102 may be running on the same hardware as the server 101 itself, or on one or more additional server computers.

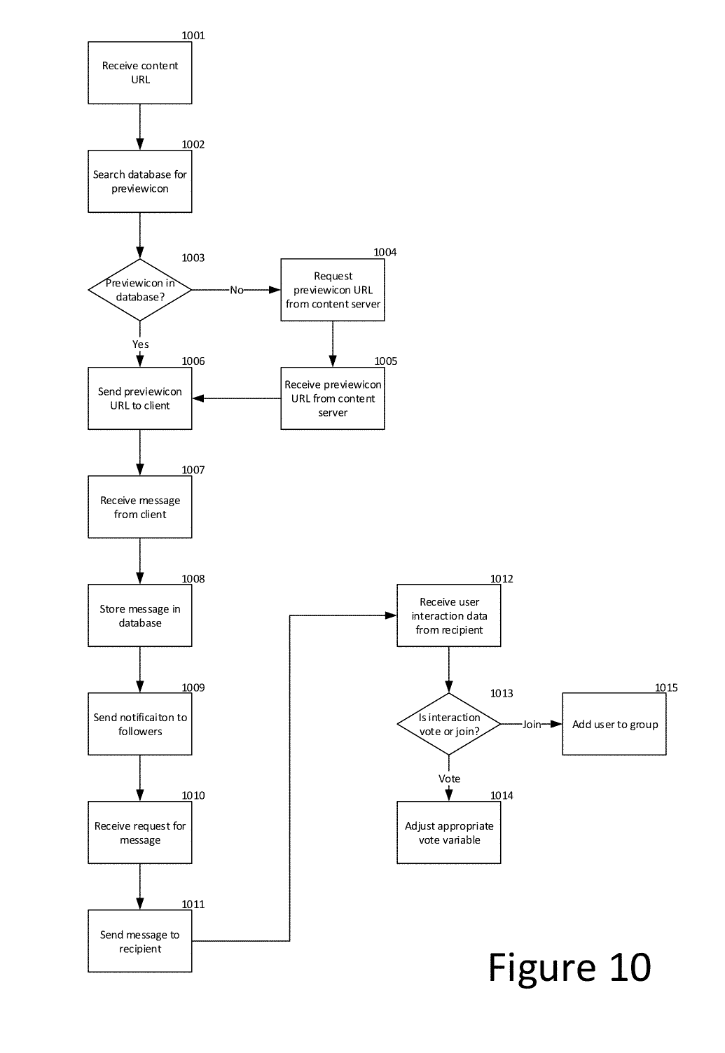

FIG. 10 is a flow chart that illustrates an embodiment of a method consistent with the principles of the invention. This method may be performed in a messaging server 101 as a way of processing messages that are received from a sender device 104 and forwarded to recipient devices 105. The method also includes communication with content servers 108 and processing of interactivity. It should, however, be noted that while the method is illustrated here as a sequence of steps that are performed consecutively, some of the steps are only performed in cases when they are required, and not necessarily in the sequence illustrated here. In particular, a messaging server will typically process a large number of messages in parallel, and one incoming message will fork into numerous outgoing messages, while only some of the outgoing messages may result in further user interaction. Also, the initial steps of processing a request for a preview icon does not have to be associated with the subsequent steps of distributing the message itself in the server, and similarly the processing of interaction does not have to be associated with the distribution of the messages in the sense that these different subsequences of the method may be performed in separate processes or threads. For the sake of simplicity, however, the method is illustrated here as one single sequence which does not fork into separate threads or processes.

As already described above, a user who is composing a message may wish to include a link sticker, an interactive element which includes a reference to content available on a content server. When the user inserts this reference, typically in the form of a URL, into the messaging client where the message is composed, the client sends a request to the messaging server 101 for a reference to a preview icon. This has been described above with reference to FIG. 5. This request is received in step 1001 by the messaging server 101. Based on the received URL a search is performed in the database 102 of the messaging server 101 in step 1002 in order to determine if a preview icon has already been identified for the server or website identified by a truncated version of the received URL.

It should be noted that different embodiments of the invention may truncate the URL more or less. For example, while some embodiments may use only the domain or subdomain of the URL to obtain a preview icon from the content server, other embodiments may use longer parts or the entire URL in order to allow the content server to provide preview icons that are specific to certain subsets of resources, or even individual resources, residing on the content server as part of the same domain. This is well known in the art, and no loss of generality is intended by the user of the term URL to refer to complete as well as truncated versions of the URL that is entered by the user when editing the message.

If a preview icon has already been obtained and the URL for the preview icon has been stored in the database, as determined in step 1003, the process proceeds to step 1006, where the preview icon URL is transmitted to the requesting client, sender device 104. If, however, it is determined in step 1003 that no preview icon for the provided URL can be identified in the database 102, a request is sent 1004 to the content server 108. In step 1005 a response including a URL for a preview icon is received from the content server 108. Of course, in some cases the content server is unable to provide any preview icon, or the response is not received in time by the messaging server 101. If this is the case, the messaging server may instead provide a default preview icon URL which links to a neutral link sticker background. In some embodiments, this neutral link sticker background is already defined in the messaging clients resident on the sender and recipient devices 104, 105 rather than being available upon request. Step 1005 may also include storing the received preview icon URL in the database 102 such that subsequent requests will not require requests from the content server 108. The received preview icon URL may then be sent to the requesting sender device 104 in step 1006.

When the user has finished creating and editing the message, the finished message is sent from the sender device 104 to be received by the messaging server in step 1007. The message is the stored 1008 in the database 102. The step of storing the message in the database includes creating the necessary entries related, for example, to interactivity, as described with reference to FIG. 8 and FIG. 9. Exactly which entries are necessary may depend both on the individual message and the capabilities included in a particular embodiment.

As described above, a message may be designated for members of one or more groups, also referred to as followers of one or more stories. In step 1009 notifications are pushed out to recipient devices 105 that are logged in with the messaging server 101 with user accounts associated with one or more of the groups. Various methods for pushing notifications to client devices are well known in the art and will not be discussed in detail here, as the selection of any particular protocol or method is beyond the scope of the invention as such.

On recipient devices 105, users are able to view the notifications they have received and request receipt of the entire message. Such requests are received by the messaging server 101 in step 1010. When such a request is received, the server 101 locates the requested message in the database 102 and transmits 1011 the relevant information to the recipient device 105 that issued the request. The message sent to the recipient device may substantially be the same as the message as it is received from the sender device as illustrated by the example in FIG. 4, but some information may be left out such as the senders user name (particularly if the message is anonymous as indicated by the ghostmode parameter) and token. Other information or fields may be added, such as variables that can be used by the client to keep track of whether the message has been liked, any of the interactive stickers have been interacted with, etc.

If the message contains one or more interactivity stickers that refer back to the messaging server 101, i.e. not link stickers that exclusively reference content available from a content server 108 other than the messaging server 101, but elements that are capable of receiving user input that initiates transmission of information back to the messaging server 101, this information will be received by the messaging server at step 1012.

Various types of interactivity stickers may send different information back to the messaging server, and the subsequent steps performed in the messaging server will depend on the information received in step 1012. Two types of interactive stickers are included in the exemplary embodiments described herein, namely vote stickers and join stickers. In step 1013 it is determined which type of interactive sticker has provided the received information. If it is determined that the information was received from a vote sticker, the method progresses to step 1014 where the appropriate variable is adjusted. The variable may be identified based on received information identifying the message and the vote sticker uniquely, as described for example with reference to FIG. 8.

It is consistent with the principles of the invention to implement different types of polls; it may for example be possible to allow voters to assign different weight to a vote, or to assign different weight to votes from different users based, for example, on some kind of authority score associated with the user. In embodiments where all votes are assigned equal weight, receipt of a vote message from a user may result in a simple increment of a counter, i.e. to increase the value stored in a variable by one. A representation of this incremented value may now be included with future requests for transmission of this particular message.

If it is determined in step 1013 that the received information has been transmitted as a result of user interaction with a join sticker, the process progresses to step 1015 where a user identified in the received information is registered as member of a group also identified in the received information.

During the performance of the steps described above, the messaging server may continually receive new requests for preview icon information initiating a new process at step 1001, new messages from sender devices 104 which initiates new processes at step 1007, new requests for receipt of messages initiating new processes at step 1010, and new interaction information at step 1012. These processes may run in parallel on the messaging server 101.

1. A method in a messaging server for providing interactive elements in messages, comprising:
receiving a message from a sender device, said message including a definition of an interactive element to be rendered in conjunction with said message on a recipient device;
storing said message, including a representation of said interactive element, in a database;
associating, in said database, the representation of said interactive element with a variable;
transmitting said message to a first recipient device together with a representation of a value stored in said variable such that said value can be presented together with said message and said interactive element on said first recipient device;
receiving a return message from said first recipient device representing a user interaction with said interactive element;
adjusting the value stored in said variable as a result of the receipt of said return message; and
transmitting said message to a second recipient device together with the adjusted value stored in said variable such that said adjusted value can be presented together with said message on said second recipient device.

2. The method according to claim 1, wherein said message, when it is transmitted to said first recipient device, includes a unique identification of said variable on the message server.

3. The method according to claim 1, further comprising:
receiving from said sender device, and prior to receiving said message from the sender device, at least a part of a URL identifying a resource that is accessible over a computer network;
searching in a database associated with the message server, for an entry associating said at least a part of a URL identifying a resource with a URL identifying a preview image representing said resource that is accessible over a computer network; and
upon retrieval of such an entry, sending the URL identifying a preview image to the sender device;
wherein said message received from a sender device includes an additional interactive element associated with said URL identifying a resource that is accessible over a computer network and said URL identifying said preview image.

4. The method according to claim 3, further comprising:
upon determining that no entry associating said at least a part of a URL identifying a resource with a URL identifying a preview image can be retrieved from said database, sending a request for a URL identifying a preview image to a server hosting the resource identified by the received URL;
receiving a response from said server hosting the resource identified by the received URL including a URL identifying a preview image, creating an entry associating said URL identifying a resource that is accessible over a computer network with said URL identifying a preview image; and
sending the URL identifying a preview image to said sender device.

5. The method according to claim 1, wherein said message received from a sender device includes an additional interactive element associated with a group of registered users, the method further comprising:
receiving a return message from said first recipient device representing a user interaction with said additional interactive element associated with a group of registered users and including an identification of a user; and
adding the identified user to said group of registered users.

6. The method according to claim 1, wherein said interactive element is configured to be displayed as superimposed on graphical multimedia content when the message is rendered.

7. The method according to claim 1, wherein said interactive element includes one or more selected from the group consisting of: a text string, an emoji, an icon, an image, and a default background pattern.

8. The method according to claim 1, further comprising:
prior to transmitting said message to said first recipient device, transmitting a notification including an identification of said message to said first recipient device; and
receiving a request for said message from said first recipient device.

9. The messaging server system for providing interactive elements in messages, comprising:
one or more processors;
a database;
one or more non-transitory computer readable storage media comprising instructions that, when executed by the one or more processors, cause the messaging server system to:
receive a message from a sender device, said message including a definition of an interactive element to be rendered in conjunction with said message on a recipient device;
upon receipt of said message, store said message, including a representation of said interactive element, in a database;
associate, in said database, the representation of said interactive element with a variable;
transmit said message to a first recipient device together with a representation of a value stored in said variable such that said value can be presented together with said message and said interactive element on said first recipient device;
receive a return message from said first recipient device representing a user interaction with said interactive element;
adjust the value stored in said variable as a result of the receipt of said return message; and
transmit said message to a second recipient device together with the adjusted value stored in said variable such that said adjusted value can be presented together with said message on said second recipient device.

10. The messaging server system according to claim 9, wherein said message, when it is transmitted to said first recipient device, includes a unique identification of said variable on the message server.

11. The messaging server system according to claim 9, wherein the instructions, when executed by the one or more processors, further causes the messaging server system to:
receive from said sender device, and prior to receiving said message from the sender device, at least a part of a URL identifying a resource that is accessible over a computer network;
searching said database for an entry associating said at least a part of a URL identifying a resource with a URL identifying a preview image representing said resource that is accessible over a computer network; and
upon retrieval of such an entry, sending the URL identifying a preview image to the sender device;
wherein said message received from a sender device includes an additional interactive element associated with said URL identifying a resource that is accessible over a computer network and said URL identifying said preview image.

12. The messaging server system according to claim 11, wherein the instructions, when executed by the one or more processors, further causes the messaging server system to:
upon determining that no such entry associating said at least a part of a URL identifying a resource with a URL identifying a preview image can be retrieved from said database, sending a request for an URL identifying a preview image to a server hosting the resource identified by the received URL;
receiving a response from said server hosting the resource identified by the received URL including a URL identifying a preview image, creating an entry associating said URL identifying a resource that is accessible over a computer network with said URL identifying a preview image; and
sending the URL identifying a preview image to said sender device.

13. The messaging server system according to claim 9, wherein said message received from a sender device includes an additional interactive element associated with a group of registered users, and wherein the instructions, when executed by the one or more processors, further causes the messaging server system to:
receive a return message from said first recipient device representing a user interaction with said additional interactive element associated with a group of registered users and including an identification of a user; and
add the identified user to said group of registered users.

14. The messaging server system according to claim 9, wherein said interactive element is configured to be displayed as superimposed on graphical multimedia content when the message is rendered.

15. The messaging server system according to claim 9, wherein said interactive element includes one or more selected from the group consisting of: a text string, an emoji, an icon, an image, and a default background pattern.

16. The messaging server system according to claim 9, wherein the instructions, when executed by the one or more processors, further causes the messaging server system to:
prior to transmitting said message to said first recipient device, transmitting a notification including an identification of said message to said first recipient device; and
receiving a request for said message from said first recipient device.

17. A computer implemented method comprising:
receiving a message request including an interactive element;
storing the message in a messaging server;
forwarding the message to one or more recipient devices;
receiving a message indicative of user interaction with said interactive element; and
incrementing a counter.

18. A computer implemented method comprising:
enable, on a sender device, a user of the sender device to create a message including one or more interactive elements;
configure a messaging server to receive messages including at least one interactive element from said sender device;
using said messaging server to store received messages in a database and create counters associated with respective interactive elements;
transmit received messages including at least one interactive element to at least one recipient device;
enable, on the at least one recipient device, a user of the recipient device to view received message and interact with interactive elements included in said received messages;
transmit, using the recipient device, a message indicative of user interaction with said interactive element to said messaging server; and
upon receiving said message indicative of user interaction with said interactive element on the messaging server, using the messaging server to increment said counter.

19. A computer program product comprising a non-transitory computer readable storage medium comprising instructions that, when executed on a processor in a messaging server, enables the messaging server to perform the steps of a method according to claim 1.
